(19) United States
(12) Patent Application Publication
(10) Pub. No.: US 2015/0008612 A1
(43) Pub. Date: Jan. 8, 2015

(54) PRODUCTION METHOD OF REINFORCED HOSE

(71) Applicant: TOYODA GOSEI CO., LTD., Kiyosu-shi, Aichi-ken (JP)

(72) Inventors: Yosuke Ishigaki, Kiyosu-shi (JP); Yasuhiro Kasai, Kiyosu-shi (JP); Tsuyoshi Kato, Kiyosu-shi (JP); Yoji Kimura, Kiyosu-shi (JP)

(21) Appl. No.: 14/378,356

(22) PCT Filed: Mar. 7, 2013
(86) PCT No.: PCT/JP2013/001437

§ 371 Date: Aug. 13, 2014

(30) Foreign Application Priority Data
Mar. 29, 2012 (JP) 2012-75460

(51) Int. Cl. B29C 47/06; B29C 47/78; B29C 71/02; B29C 47/00

(52) U.S. Cl. CPC B29C 47/065; B29C 47/0026; B29C 47/782; B29C 71/02; B29K 2023/16
USPC 264/171.12

(57) ABSTRACT

A brake hose 10 is produced by: an inner tube rubber forming step of extrusion molding a rubber tubular body 12A to form an inner tube rubber layer 12; a braiding step of forming a reinforcing yarn layer 13 on the rubber tubular body 12A to produce a braided hose body 12C; and an outer surface rubber forming step of coating the braided hose body with an outer surface rubber material to form an outer surface rubber layer 20. The outer surface rubber forming step heats the braided hose body 12C such that surface temperature Th of the braided hose body 12C is equal to or higher than 50° C. and coats the braided hose body 12C with the outer surface rubber material under an atmosphere set to a lower pressure than the atmospheric pressure, which is equal to or lower than 0.8 atmospheres, in a region where the braided hose body 12C is to be coated with the outer surface rubber material.

### TECHNICAL FIELD

The present invention relates to a production method of a reinforced hose, such as a hydraulic hose, used for a fuel path of a pressure fluid and configured to have reinforcing yarn braided on an inner tube rubber layer.

### BACKGROUND ART

A known method of producing a brake hose used for the automobile, which is included in such reinforced hoses, forms a reinforcing yarn layer on an inner tube rubber layer, additionally forms an outer surface rubber layer on the reinforcing yarn layer and places this layered structure in a sealed vulcanizing vessel to heat and vulcanize the layered structure under a pressure of or over atmospheric pressure, so as to produce the brake hose. The vulcanizing step which is one step of this production method uses the sealed and pressurized vulcanizing vessel and accordingly has low productivity. The technique disclosed in Patent Literature 1 has been proposed to improve the productivity. More specifically, the method of Patent Literature 1 forms a hose intermediate product by braiding a reinforcing yarn layer made of fibers on an inner tube rubber layer, heats the hose intermediate body by radio-frequency heating to coat the outer circumference of the hose intermediate body with an outer surface rubber layer and a cover layer and then causes the coated hose intermediate product to pass through a vulcanizing vessel set under ordinary pressure, so as to continuously vulcanize the coated hose intermediate product. This method continuously vulcanizes the hose intermediate product and accordingly has excellent productivity.

In the application of the above prior art method to a brake hose, however, there is a problem that the outer surface rubber layer and the cover layer are likely to be partly swelled.

### CITATION LIST

### Patent Literature

PLT 1: JP 3960362B

### SUMMARY OF INVENTION

### Technical Problem

By taking account such circumstances, an object of the invention is to provide a production method of producing a brake hose without causing any partial well of an outer surface rubber layer with excellent productivity.

### Solution to Problem

In order to achieve at least part of the above object, the present invention may be implemented by the following aspects or embodiments.

### [Aspect 1]

According to Aspect 1, there is provided a production method of a reinforced hose having: an inner tube rubber layer; a reinforcing yarn layer formed on braiding a reinforcing yarn on the inner tube rubber layer; and an outer surface rubber layer formed to coat the reinforcing yarn layer. The production method comprises: a step of providing a braided hose body having the reinforcing yarn layer formed on the inner tube rubber layer; and an outer surface rubber forming step of extruding an unvulcanized rubber material on the braided hose body to form the outer surface rubber layer. The outer surface rubber forming step heats the braided hose body such that surface temperature Th of the braided hose body is equal to or higher than 50° C., sets an atmosphere in a region where the braided hose body is to be coated with the rubber material to an atmosphere of a lower pressure than atmospheric pressure, which is equal to or lower than 0.8 atmospheres, and coats the braided hose body with the unvulcanized rubber material under the atmosphere to produce a hose intermediate product.

In the outer surface rubber forming step according to Aspect 1, the braided hose body is heated to or over 50° C. for evaporation and removal of moisture on its surface, before the braided hose body is coated with the unvulcanized rubber material. Additionally, the atmosphere in the region where the braided hose body is to be coated with the unvulcanized rubber material is set to the atmosphere of the reduced pressure to be not greater than 0.8 atmospheres. The braided hose body is coated with the rubber material under this atmosphere. The rubber material accordingly coats the braided hose body without taking in the moisture or the air in the atmosphere of removed moisture and reduced pressure and enters into the depth of even narrow gaps between reinforcing yarns of the braided hose body. This eliminates a potential defect caused by evaporation of the moisture or expansion of the air between the braided hose body and the outer surface rubber layer by the heat in the process of vulcanizing the hose intermediate product having the braided hose body coated with the outer surface rubber material under atmospheric pressure, e.g., a partial swell of the outer surface of the reinforced hose.

### [Aspect 2]

According to Aspect 2, there is provided the production method of the reinforced hose, further comprising a step of vulcanizing the hose intermediate product having the braided hose body coated with the outer surface rubber material under atmospheric pressure, after the outer surface rubber forming step.

### [Aspect 3]

According to Aspect 3, there is provided the production method of the reinforced hose, wherein when the surface temperature Th of the braided hose body is lower than temperature Tr, a temperature difference between Th and Tr is equal to or less than 10° C., wherein Tr is the temperature of the rubber material during the step of coating the braided hose body with the rubber material.

### [Aspect 4]

According to Aspect 4, there is provided the production method of the reinforced hose, wherein the step of heating the braided hose body blows a hot blast onto outer surface of the braided hose body. This method enables the moisture on the braided hose body to be removed efficiently.

### [Aspect 5]

According to Aspect 5, there is provided the production method of the reinforced hose, wherein the reinforcing yarn has a product of thickness and number of carriers equal to 40000 to 70000 dtex·carriers. More preferably, the reinforcing yarn has a product of 50000 to 650000 dtex·carriers. The number of carriers herein is expressed by the sum of the number of carriers in an upper yarn layer and the number of carriers in a lower yarn layer, when the reinforcing yarn layer has the upper yarn layer and the lower yarn layer.

### [Aspect 6]

According to Aspect 6, there is provided the production method of the reinforced hose, wherein. the reinforcing yarn layer is formed by sequentially stacking a lower yarn layer, an intermediate rubber layer and an upper yarn layer from an inner tube rubber layer side, and the lower yarn layer and the upper yarn layer are formed by using 20 to 24 carriers.

### [Aspect 7]

According to Aspect 7, there is provided the production method of the reinforced hose, wherein the reinforcing yarn layer is formed by sequentially stacking a lower yarn layer, an intermediate rubber layer and an upper yarn layer from an inner tube rubber layer side, and the lower yarn layer is formed by using a reinforcing yarn made of polyester yarn having a tensile strength per unit decitex equal to or greater than 6.9 g and an elongation rate of 2.6±1.0% under 2.7 g load.

### [Aspect 8]

According to Aspect 8, there is provided the production method of the reinforced hose, wherein a reinforcing yarn of the lower yarn layer is braided at a braid angle of 59±1 degrees relative to an axial direction of the hose.

### [Aspect 9]

According to Aspect 9, there is provided the production method of the reinforced hose, wherein the inner tube rubber layer has a thickness of 0.6±0.2 mm.

### [Aspect 10]

According to Aspect 10, there is provided the production method of the reinforced hose, wherein the intermediate rubber layer has a thickness of 0.1 to 0.35 mm.

### BRIEF DESCRIPTION OF DRAWINGS

FIG. 1 is a partly cutaway perspective view illustrating a brake hose according to an embodiment of the invention;

FIG. 2 is a half sectional view of the brake hose;

FIG. 3 is a diagram illustrating the braid angle of a lower yarn layer;

FIG. 4 is a diagram illustrating an inner tube rubber extrusion step;

FIG. 5 is a diagram illustrating a reinforcing yarn braiding step;

FIG. 6 is a diagram illustrating an adhesive applying step;

FIG. 7 is a diagram illustrating an outer surface rubber forming step and a vulcanizing step;

FIG. 8 is a diagram illustrating a step of coating a braided hose body with an outer surface rubber material; and

FIG. 9 is a chart illustrating a relationship between preheating temperature and atmospheric pressure.

### DESCRIPTION OF EMBODIMENTS

In order to further clarity the configurations and the functions of the present invention described above, the following describes embodiments of the present invention.

### (1) General Structure of Brake Hose 10

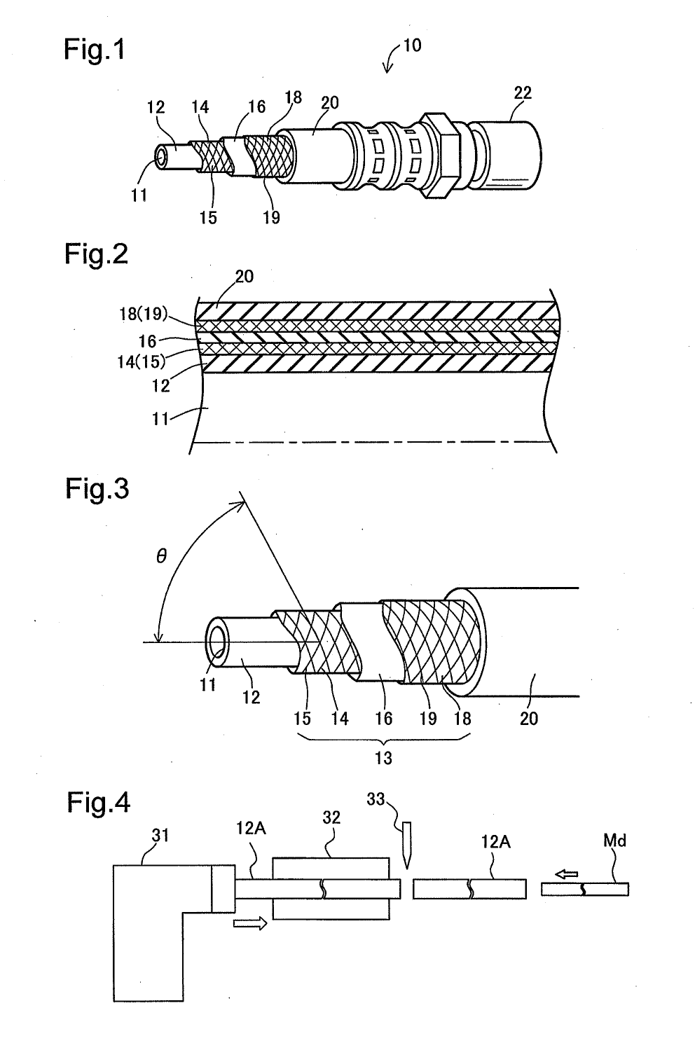

FIG. 1 is a partly cutaway perspective view illustrating a brake hose 10 according to one embodiment of the invention. FIG. 2 is a half sectional view of the brake hose 10. With referring to FIGS. 1 and 2, the brake hose 10 is used to connect a master cylinder employed for hydraulic brake of an automobile (not shown) with a hydraulic unit on the wheel side and has a five-layered structure to be resistant against the brake fluid pressure. More specifically, the brake hose 10 includes an inner tube rubber layer 12 with a flow path 11, a reinforcing yarn layer 13 and an outer surface rubber layer 20 and is clamped by caulking at one end using a hose connector 22. The reinforcing yarn layer 13 includes a lower yarn layer 14, an intermediate rubber layer 16 and an upper yarn layer 18 and enhances the resistance against the brake fluid pressure by the reinforcing yarn between the inner tube rubber layer 12 and the outer surface rubber layer 20.

### (2) Structure of Respective Layers of Brake Hose 10

The materials, the thicknesses, the braid angles and other conditions of the respective layers are specified to obtain the properties such as the pressure resistance to be resistant against the brake fluid pressure up to 50 MPa, the durability and the expansion resistance.

(2)-1. Inner Tube Rubber Layer 12

The inner tube rubber layer 12 is formed by extrusion molding using, for example, ethylene propylene diene monomer (EPDM) rubber or styrene butadiene rubber (SBR) copolymer to obtain mainly the oil resistance. The inner tube rubber layer 12 has the inner diameter of 3.0 to 3.4 mm and the thickness of 0.4 to 0.8 mm.

(2)-2. Lower Yarn Layer 14

The lower yarn layer 14 is formed by braiding 1100-dtex lower yarn 15 comprised of two-strand or three-strand high modulus PET yarns, on the inner tube rubber layer 12 by 20 carriers or 24 carriers. The high modulus PET yarn is comprised of polyester filament yarns having the tensile strength of not less than 6.9 g per unit decitex and the elongation rate of 2.6±1.0% under 2.7 g load or more preferably polyester filament yarns having the tensile strength of not less than 6.9 g per unit decitex and the elongation rate of 2.6±0.5% under 2.7 g load. The high modulus PET yarn of the lower yarn 15 is formed by bundling 200 to 400 filament yarns. The thickness of the lower yarn layer 14 is 0.55 to 0.95 mm and is preferably 0.65 to 0.85 mm.

FIG. 3 is a diagram illustrating the braid angle of the lower yarn layer 14. The lower yarn layer 14 is provided by helically braiding the lower yarn 15 at a braid angle θ on the inner tube rubber layer 12. The braid angle θ herein denotes an angle of the lower yarn 15 to the axial direction of the completed product of the brake hose 10 in the state with no application of brake fluid pressure. The braid angle θ of the lower yarn layer 14 is not to 59±1 degrees, in order to reduce the volume expansion. The volume expansion herein denotes an expansion of the volume of the brake hose by the brake fluid pressure in the state that the brake hose is mounted on the vehicle. The greater volume expansion indicates the slower response of the brake pedal depression and the poorer operation feeling. The setting of this braid angle θ may be varied, for example, by the ratio of the pull-out speed of the inner tube rubber layer to the rotation speed of a braider in the case of braiding on the inner tube rubber layer using the braider during extrusion molding.

(2)-3. Intermediate Rubber Layer 16

The intermediate rubber layer 16 is provided as a layer to prevent misalignment of the lower yarn layer 14 and the upper yarn layer 18 and is formed by extruding a rubber material on the lower yarn layer 14, by winding a sheet material 16A on the lower yarn layer 14 or applying a gum on the lower yarn layer 14. The rubber material used may be, for example, EPDM, isobutylene-isoprene copolymer (IIR) or natural rubber (NR). Using EPDM, IIR, or a blended material thereof enhances the heat resistance, due to their physical properties. The thickness of the intermediate rubber layer 16 is preferably 0.1 to 0.35 mm. More specifically, the intermediate rubber layer 16 of less than 0.1 mm is too thin to be formed on the lower yarn layer 14. The thickness of greater than 0.35 mm, on the other hand, causes the thick intermediate rubber layer 16 to serve as an elastic layer that allows misalignment of the lower yarn layer 14 and reduces the effect of preventing misalignment of the lower yarn layer 14.

(2)-4. Upper Yarn Layer 18

The upper yarn layer 18 is formed by braiding 1700-dtex upper yarn 19 on the intermediate rubber layer 16 by 20 carriers or 24 carriers. The upper yarn 19 is comprised of two-strand or three-strand high modulus PET yarns, each obtained by bundling 200 to 400 filament yarns like the lower yarn 15 and subjected to RFL treatment. Like the lower yarn layer 14, the braid angle of the upper yarn layer 18 is preferably set to 59±1 degrees, in order to reduce the volume expansion. The upper yarn layer 18 is obtained by applying an undercoat layer after bundling the filament yarns and performing RFL treatment. The RFT treatment herein causes the surface of the yarn to he coated with an adhesive thin film that serves as an adhesive mainly consisting of resorcinol formaldehyde latex resin and rubber latex. The lower yarn layer 14 may also be subjected to the RFL treatment. This further enhances the adhesive strength with the intermediate rubber layer 16.

(2)-5. Outer Surface Rubber Layer 20

The outer surface rubber layer 20 is made of, for example, EPDM or a blended material of EPDM and CR, in order to mainly obtain the ozone resistance. The thickness of the outer surface rubber layer 20 is 0.8 to 1.3 mm.

### (3) Production Method of Brake Hose 10

The following describes the production method of the brake hose 10. The brake hose 10 is produced by sequentially performing an inner tube rubber forming step, a reinforcing yarn braiding step, an adhesive applying step, an outer surface rubber forming step and a vulcanizing step. Other steps, for example, a drying step may be added adequately to these steps. FIGS. 3 to 8 are diagrams illustrating production steps of the brake hose 10.

(3)-1. Inner Tube Rubber Forming Step

FIG. 4 is a diagram illustrating an inner tube rubber extrusion step. An apparatus used for forming the inner tube rubber includes a first extrusion device 31, a cooling device 32 and a cutter 33. The step using this apparatus extrudes an inner tube rubber material made of EPDM rubber by the first extrusion device 31 to form a rubber tubular body 12A for formation of the inner tube rubber layer 12, cools down the rubber tubular body 12A by the cooling device 32, cuts the rubber tubular body 12A to a specified length (for example, 3500 mm) by the cutter 33 and then inserts a mandrel Md into the cut rubber tubular body 12A.

(3)-2. Reinforcing Yarn Braiding Step

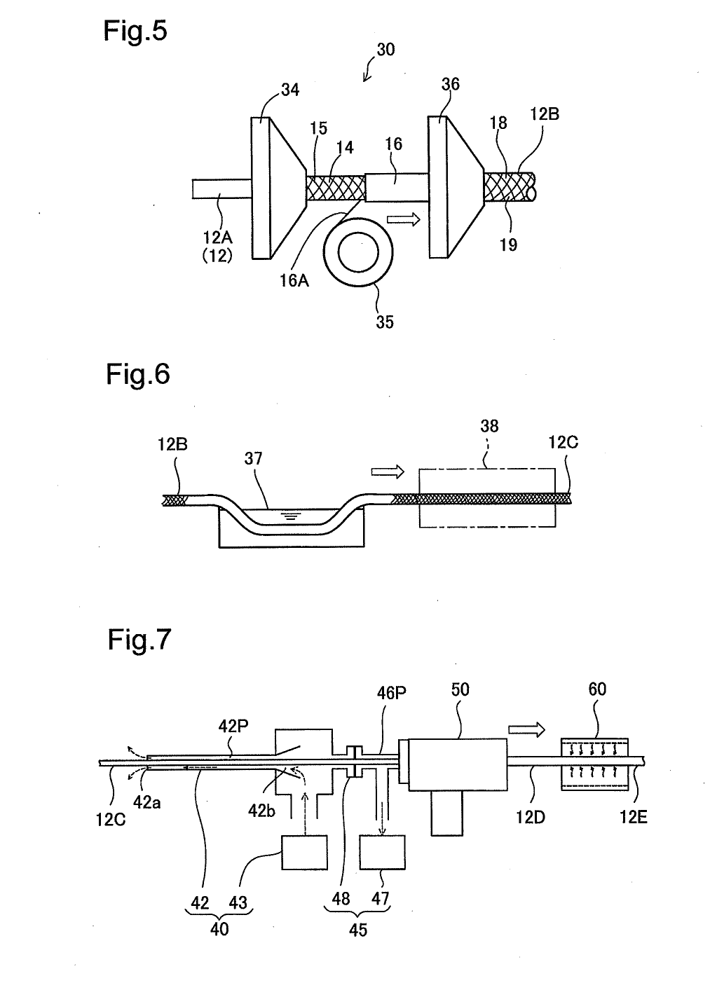

FIG. 5 is a diagram illustrating a reinforcing yarn braiding step. An apparatus used for braiding the reinforcing yarn includes a first braiding device 34, an intermediate sheet forming device 35 and a second braiding device 36. The first braiding device 34 has bobbin carriers mounted on a drum and serves to braid the lower yarn 15 pulled out from the bobbin carriers on the rubber tubular body 12A and thereby form the lower yarn layer 14. The intermediate sheet forming device 35 serves to pull out a sheet material 16A for formation of the intermediate rubber layer 16 from a roller onto the lower yarn layer 14 braided by the first braiding device 34. The second braiding device 36 has almost the same configuration as that of the first braiding device 34 to have bobbin carriers mounted on the drum and serves to braid the upper yarn 19 pulled out from the bobbin carriers on the intermediate rubber layer 16 and thereby form the upper yarn layer 18.

The step of braiding the reinforcing yarn on the rubber tubular body 12A using this apparatus first braids the lower yarn 15 on the rubber tubular body 12A to form the lower yarn layer 14 by the first braiding device 34. The step subsequently winds the sheet material 16A, which is pulled out from the roller to coat the lower yarn layer 14, on the lower yarn layer 14 to form the intermediate rubber layer 16 by the intermediate sheet forming device 35. The step subsequently braids the upper yarn 19 on the intermediate rubber layer 16 to form the upper yarn layer 18 by the second braiding device 36. The braid angle θ of the lower yarn layer 14 and the upper yarn layer 18 is set to 59±1 degrees by the ratio of the pull-out speed of the inner tube rubber layer 12 to the rotation speed of the drum. This step accordingly forms a braided hose body 12B.

(3)-3. Adhesive Applying Step

FIG. 6 is a diagram illustrating an adhesive applying step. An apparatus used for this step includes an adhesive tank 37 containing an adhesive solution and a drying device 38. The step using this apparatus soaks the braided hose body 12B after braiding the upper yarn layer 18 in an RFL adhesive solution in the adhesive tank 37. The RFL adhesive solution is a mixed solution of an aqueous initial condensate of resorcinol formaldehyde and rubber latex as mentioned above. The step subsequently dries an extruded tubular body 18A at 90 to 200° C. to dry the RFL adhesive solution by the drying device 38. This step accordingly forms a braided hose body 12C having the reinforcing yarn layer 13 formed on the rubber tubular body 12A.

(3)-4. Outer Surface Rubber Forming Step

FIG. 7 is a diagram illustrating a preheating step, a pressure reduction step, an outer surface rubber forming step and a vulcanizing step. With regard to these steps, the preheating step is performed by a preheating device 40; the pressure reduction process is performed by a decompression device 45; and the outer surface rubber forming step is performed by a second extrusion device 50. The preheating device 40 preheats the braided hose body 12C conveyed from the previous step and includes a conveyor unit 42 having a conveyor path 42P and a hot air blower 43 connected with the conveyor unit 42. The decompression device 45 includes a conveyor path 46P arranged to connect the conveyor path 42P with the second extrusion device 50, a vacuum pump 47 and a sealing unit 48. The second extrusion device 50 serves to extrude a rubber material onto the braided hose body 12C to form the outer surface rubber layer 20.

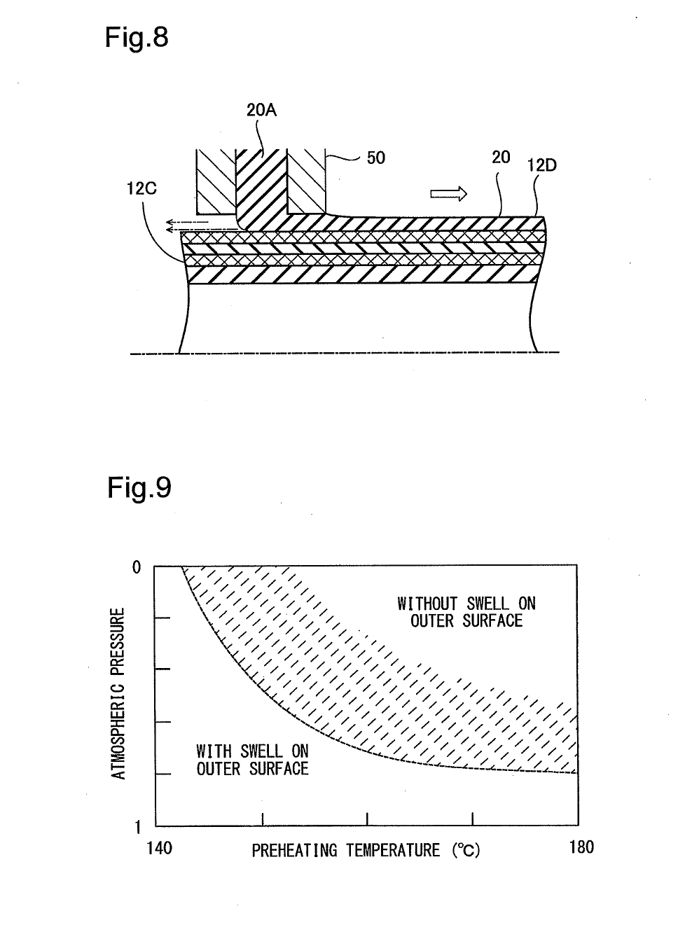

The braided hose body 12C is coated with the outer surface rubber layer 20 by the following steps using the devices shown in FIG. 7. The hot air blower 43 of the preheating device 40 is operated to blow the hot air from an outlet 42b to an inlet 42a of the conveyor unit 42, so as to preheat the braided hose body 12C. The temperature of the hot air blown by the hot air blower 43 is 90 to 250° C. The braided hose body 12C is conveyed through the sealing unit 48 on the conveyor path 46P to the second extrusion device 50. This conveyor path 46P is decompressed by the vacuum pump 47. In other words, the upstream side of the second extrusion device 50 is decompressed. As shown in FIG. 8, an unvulcanized outer surface rubber material 20A heated to 50 to 130° C. is fed onto the outer circumference of the braided hose body 12C by the second extrusion device 50, so as to form the outer surface rubber layer 20. During this process, the pressure is reduced in the region where the braided hose body 12C is to be coated with the outer surface rubber material.

(3)-5. Vulcanizing Step

A vulcanizer 60 is heated with a heater (not shown) to be set to an atmosphere of ordinary pressure and a specified temperature. A hose intermediate product 12D is continuously vulcanized by this vulcanizer 60. The vulcanizing conditions may be set to 120 to 250° C. for 5 to 60 minutes. The heating in this vulcanizing step causes the RFL-treated upper yarn layer 18 and the lower yarn layer 14 to adhere to the inner tube rubber layer 12, the intermediate rubber layer 16 and the outer surface rubber layer 20.

A hose 12E is then subjected to a post process, for example, cutting to a specified length. This completes the brake hose 10 shown in FIG. 1.

### (4) Functions and Advantageous Effects of Brake Hose

(4)-1. With referring to FIGS. 7 and 8, the braided hose body 12C conveyed to the second extrusion device 50 has been subjected to evaporation and removal of moisture on its surface by the preheating device 40. Additionally, the pressure is reduced in the region where the braided hose body 12C is to be coated with the outer surface rubber material 20A. Accordingly the braided hose body 12C is coated with the outer surface rubber material 20A in the atmosphere of removed moisture and reduced pressure, so that the outer surface rubber material 20A enters into the depth between the reinforcing yarns of the braided hose body 12C. This eliminates a potential defect caused by evaporation of the moisture or expansion of the air between the hose intermediate product 12D and the outer surface rubber material 20A by the heat in the process of vulcanizing the hose intermediate product 12D having the braided hose body 12C coated with the outer surface rubber material 20A under atmospheric pressure, e.g., a partial swell of the outer surface of the brake hose 10.

In order to check the properties of the brake hose according to the above embodiment, a brake hose 10 having the inner diameter of 3.1 to 3.2 mm and the outer diameter of 10.2 to 10.5 mm was produced. The appearance of the brake hose 10 was visually checked. According to the result of checking, no partial swell was observed on the outer surface rubber layer 20.

The conditions set for the preheating device 40 and the decompression device 45 shown in FIG. 7 were examined to eliminate a swell of the outer surface rubber layer 20 of the brake hose 10 in the outer surface rubber forming step. FIG. 9 is a chart illustrating a relationship between preheating temperature and atmospheric pressure. The abscissa of FIG. 9 shows the temperature of the but air blown by the hot air blower 43, and the ordinate shows the atmospheric pressure. As shown in an area surrounded by slant lines in FIG. 9, decompression to or below 0.8 atmospheres causes the outer surface rubber layer 20 of the brake hose 10 to have no swell. The force required to tear the outer surface rubber layer 20 from the brake hose 10 was measured. According to the result of measurement, producing the brake hose 10 under the conditions of the high preheating temperature and the reduced pressure increases the adhesive strength.

(4)-2. It is preferable to set the temperature of the hot air in the preheating process to satisfy the following conditions. With referring to FIG. 8, when the braided hose body 12C has a lower temperature than the temperature of the unvulcanized rubber used for formation of the outer surface rubber layer 20 and especially has a large temperature difference, the rubber material is unlikely to enter into the yarns of the upper yarn layer 18 of the braided hose body 12C. Additionally, the rubber material is also unlikely to adhere to the adhesive applied on the braided hose body 12B described with reference to FIG. 6. The surface temperature of the braided hose body 12C exceeding a specified temperature is, on the other hand, likely to cause deterioration of the upper yarn layer 18. The outer surface rubber material shown in FIG. 8 is extruded at 50 to 130° C. onto the braided hose body 12C. It is accordingly preferable to preheat the braided hose body 12C with the hot air, such that the surface temperature of the braided hose body 12C is kept at or above 90° C. In order to maintain such surface temperature, the temperature of the hot air blown by the hot air blower 43 of the preheating device 40 is preferably not lower than 90° C. When surface temperature Th of the braided hose body 12C is lower than temperature Tr of the rubber material extruded to coat the braided hose body 12C, the temperature difference between Th and Tr is preferably not greater than 10° C. This enhances the adhesive strength between the outer surface rubber layer 20 and the braided hose body 12C. In order to prevent deterioration of the upper yarn layer 18, it is preferable to keep the surface temperature of the braided hose body 12C to be not higher than 200° C.

(4)-3. With referring to FIG. 7, the braided hose body 12C is heated with the hot air, so that the moisture on the braided hose body 12C is removed with high efficiency by the decompression device 45.

(4)-4. With referring to FIG. 7, the hose intermediate product 12D is vulcanized not by a sealed vulcanizing vessel but by the vulcanizer 60 that continuously vulcanizes the hose intermediate product 12D under ordinary pressure. This simplifies the structure of the vulcanizer 60 itself and ensures the excellent productivity.

(4)-5. The brake hose 10 has the inner tube rubber layer 12, the lower yarn layer 14, the intermediate rubber layer 16 and the upper yarn layer 18 of the following configuration to reduce the volume expansion of the brake hose by the brake fluid pressure and ensure the excellent brake operation feeling in the application of the brake hose mounted on the vehicle. Specifically, the reinforcing yarns of the lower yarn layer 14 and the upper yarn layer 13 are made of the polyester yarns having the tensile strength of not less than 6.9 g per unit decitex and the elongation rate of 2.6±1.0% under 2.7 g load and have the thickness of 1100±100 dtex. The braid angle of the lower yarn layer 14 to the axial direction of the hose is set to 59±1 degrees. The thickness of the inner tube rubber layer 12 is set to 0.6±0.2 mm, and the thickness of the intermediate rubber layer 16 is set to 0.1 to 0.35 mm.

The invention is not limited to the above embodiment, but a diversity of variations and modifications may be made to the embodiment without departing from the scope of the invention. Some examples of possible modification are described below.

In the above embodiment the vulcanizing step vulcanizes the hose intermediate product 12D with continuously conveying the hose intermediate product 12D as shown in FIG. 7. This is, however, not restrictive. Alternatively a vulcanizing vessel may be used in the vulcanizing step. In the latter case, vulcanization may be performed under a lower pressure than about 1.5 atmospheres, which is the general pressure in the conventional vulcanizing process.

The above embodiment describes the process of heating the braided hose body 12C with the hot air of the preheating device 40 as shown in FIG. 7. The heating technique is, however, not limited to hot air heating but may be radio-frequency heating alone or may be combination of radio-frequency heating with hot air heating or another heating means.

The above embodiment describes the production method of the brake hose as an application of the production method of the reinforced hose. This is, however, not restrictive. The production method of the reinforced hose is applicable to any high-pressure hose, for example, a hose for power steering of the automobile and a hydraulic hose for construction machines.

### REFERENCE SIGNS LIST

10 Brake hose
11 Flow path
12 Inner tube rubber layer
12A Rubber tubular body
12B Braided hose body
12C Braided hose body
12D Hose intermediate product
12E Hose
13 Reinforcing yarn layer
14 Lower yarn layer
15 Lower yarn
16 Intermediate rubber layer
16A Sheet material
18 Upper yarn layer
18A Extruded tubular body
19 Upper yarn
20 Outer surface rubber layer
20A Outer surface rubber material
22 Hose connector
31 First extrusion device
32 Cooling device
33 Cutter
34 First braiding device
35 Intermediate sheet forming device
36 Second braiding device
37 Adhesive tank
38 Drying device
40 preheating device
42 Conveyor unit
42P Conveyor path
42a Inlet
42b Outlet
43 Hot air blower
45 Decompression device
46P Conveyor path
47 Vacuum pump
48 Sealing unit
50 Second extrusion device
60 Vulcanizer
Md Mandrel

1. A production method of a reinforced hose having: an inner tube rubber layer; a reinforcing yarn layer formed on braiding a reinforcing yarn on the inner tube rubber layer; and an outer surface rubber layer formed to coat the reinforcing yarn layer, the production method comprising:
a step of providing a braided hose body having the reinforcing yarn layer formed on the inner tube rubber layer; and
an outer surface rubber forming step of extruding an unvulcanized rubber material on the braided hose body to form the outer surface rubber layer, wherein
the outer surface rubber forming step heats the braided hose body such that surface temperature Th of the braided hose body is equal to or higher than 50° C., sets an atmosphere in a region where the braided hose body is to be coated with the rubber material to an atmosphere of a lower pressure than atmospheric pressure, which is equal to or lower than 0.8 atmospheres, and coats the braided hose body with the unvulcanized rubber material under the atmosphere to produce a hose intermediate product.

2. The production method of the reinforced hose according to claim 1, further comprising:
a step of vulcanizing the hose intermediate product produced by the outer surface rubber forming step under atmospheric pressure.

3. The production method of the reinforced hose according to claim 2,
wherein when the surface temperature Th of the braided hose body is lower than temperature Tr, a temperature difference between Th and Tr is equal to or less than 10° C., wherein Tr is the temperature of the rubber material during the step of coating the braided hose body with the rubber material.

4. The production method of the reinforced hose according to claim 3,
wherein the step of heating the braided hose body blows a hot blast onto outer surface of the braided hose body.

5. The production method of the reinforced hose according to claim 4,
wherein the reinforcing yarn has a product of thickness and number of carriers equal to 40000 to 70000 dtex·carriers.

6. The production method of the reinforced hose according to claim 5,
wherein the reinforcing yarn layer is formed by sequentially stacking a lower yarn layer, an intermediate rubber layer and an upper yarn layer from an inner tube rubber layer side, and
the lower yarn layer and the upper yarn layer are formed by using 20 to 24 carriers.

7. The production method of the reinforced hose according to claim 5,
wherein the reinforcing yarn layer is formed by sequentially stacking a lower yarn layer, an intermediate rubber layer and an upper yarn layer from an inner tube rubber layer side, and
the lower yarn layer is formed by using a reinforcing yarn made of polyester yarn having a tensile strength per unit decitex equal to or greater than 6.9 g and an elongation rate of 2.6±1.0% under 2.7 g load.

8. The production method of the reinforced hose according to claim 6,
wherein a reinforcing yarn of the lower yarn layer is braided at a braid angle of 59±1 degrees relative to an axial direction of the hose.

9. The production method of the reinforced hose according to claim 6,
wherein the inner tube rubber layer has a thickness of 0.6±0.2 mm.

10. The production method of the reinforced hose according to claim 6,
wherein the intermediate rubber layer has a thickness of 0.1 to 0.35 mm.

11. The production method of the reinforced hose according to claim 1,
wherein the step of heating the braided hose body blows a hot blast onto outer surface of the braided hose body.

12. The production method of the reinforced hose according to claim 11,
wherein a reinforcing yarn of the lower yarn layer is braided at a braid angle of 59±1 degrees relative to an axial direction of the hose.

13. The production method of the reinforced hose according to claim 11,
wherein the inner tube rubber layer has a thickness of 0.6±0.2 mm.

14. The production method of the reinforced hose according to claim 11,
wherein the intermediate rubber layer has a thickness of 0.1 to 0.35 mm.

15. The production method of the reinforced hose according to claim 1, wherein the reinforcing yarn has a product of thickness and number of carriers equal to 40000 to 70000 dtex·carriers.

16. The production method of the reinforced hose according to claim 1,
wherein the reinforcing yarn layer is formed by sequentially stacking a lower yarn layer, an intermediate rubber layer and an upper yarn layer from an inner tube rubber layer side, and
the lower yarn layer and the upper yarn layer are formed by using 20 to 24 carriers.

17. The production method of the reinforced hose according to claim 1,
wherein the reinforcing yarn layer is formed by sequentially stacking a lower yarn layer, an intermediate rubber layer and an upper yarn layer from an inner tube rubber layer side, and
the lower yarn layer is formed by using a reinforcing yarn made of polyester yarn having a tensile strength per unit decitex equal to or greater than 6.9 g and an elongation rate of 2.6±1.0% under 2.7 g load.
